(19) United States
(12) Patent Application Publication
(10) Pub. No.: US 2011/0185603 A1
(43) Pub. Date: Aug. 4, 2011

(54) DREDGE FRAME

(75) Inventor: Richard Gidney, Dumfries and Galloway (GB)

(73) Assignee: Deeside Marine Limited, Dumrries and Galloway (GB)

(21) Appl. No.: 13/059,438

(22) PCT Filed: Aug. 19, 2009
(86) PCT No.: PCT/GB2009/002022

§ 371 Date: Mar. 31, 2011

(30) Foreign Application Priority Data
Aug. 19, 2008 (GB) 0815114.4

(51) Int. Cl. A01K 80/00

(52) U.S. Cl. 37/316

(57) ABSTRACT

A frame for a fishing dredge which has a sea bed engaging portion and an upper portion. Teeth are resiliently mounted on the frame to extend beyond the seabed engaging portion of the frame such that at least two of the teeth are resiliently mounted to move independently of one another. This feature allows the frame to move over obstacles encountered on the sea bed. The frame is also provided with funnelling means adapted to direct water into and through the frame in order to clear debris from the frame.

### INTRODUCTION

The present invention relates to a fishing dredge and in particular to a frame for a fishing dredge.

### BACKGROUND OT THE INVENTION

Dredging is used for harvesting bivalve molluscs such as oysters, clams and scallops. A dredge is a metal framed basket attached to a set of connected iron rings or wire netting called a belly or chain belly. The lower edge of the frame has a raking bar, with or without teeth or swords depending upon the species of mollusc that is being caught. In use, the catch is lifted off the seabed or out of the sea by the raking (or teeth) bar and passes back into a basket or bag known as a belly. Depending on the size of the boat and the depth of water fished the number of dredges or ‘bags’ may vary from a single dredge towed behind the vessel to from 5 to 20 or more dredges per side. Dredges are generally attached to a towing bar and one is operated from each side of the vessel simultaneously.

Dredging for molluscs will now be described in more detail with reference to FIGS. 1 to 3. FIG. 1 shows a trawler 1 which has a tether or trawl warp 3 connected between the winch of the boat and a dredge 5 which is pulled along the sea bed 9. FIG. 2 shows the features of a typical dredge set up. The dredges 11 are connected to the trawler via the trawl warp 3 which connects to a towing triangle 13. Four chain bridles 15 extend from the towing triangle 13 and are connected to a tow bar which has a pair of bobbin wheels 17. The tow bar couples the chain bridles 15 to dredges 21.

The dredges 21 are shown in more detail in FIG. 3. In this figure dredge 23 comprises a frame 25 and a net bag 26. The frame is typically made from steel and has a plurality of teeth or swords 31 which extend downwards from the frame. Eyebolt 27, H-plate 29, spring 32 and paw 33 provide the mechanism by which the sword 31 engages with the sea bed in order to disturb the molluscs. In use, the molluscs are dug out from the sea bed by the sword 31, they gather along the front surface of the frame 34 and then they pass through the frame into the net 26.

The teeth 31 mounted on the tooth bar are fixed in position and are connected to the frame at a pivot point towards the top of the frame. The tooth bar is also attached to a compression spring 32. In normal use the teeth 31 are retained in the downward position in which they dig into the seabed to uncover molluscs. However when a tooth encounters a hard object such as a stone, the tooth bar moves about the pivot point to raise the tooth bar and move over the object. This prevents the tooth bar from getting stuck on the sea bed. However, raising the tooth bar also means that the molluscs that have accumulated on the front of the tooth bar escape under the raised toothbar.

Dredging in general is viewed as having a significant environmental impact because it agitates the sea bed and in the process causes significant damage. In addition, the act of dragging the dredges along the sea bed requires the trawler to use significant amounts of fuel to power its engines.

### SUMMARY OF THE INVENTION

In accordance with a first aspect of the invention there is provided a frame for a fishing dredge, the frame comprising:
a sea bed engaging portion and an upper portion;
a mounting means located on the frame;
a plurality of teeth which are coupled to the mounting means said teeth extending beyond the seabed engaging portion of the frame; and wherein at least two of the teeth are resiliently mounted to move independently of one another.

Preferably, the seabed engaging portion of the frame further comprises one or more runner.

Preferably, the seabed engaging portion of the frame further comprises one or more wheel.

Optionally, the seabed engaging portion of the frame further comprises one or more track.

Preferably, the track is moveable.

Optionally the track is flexible.

Preferably at least two of said teeth are mounted on seperately resiliently mounted.

Preferably, the teeth are resiliently mounted by means of a spring.

Preferably, the spring is coiled around the mounting means.

Optionally, the spring couples the mounting means to the tooth.

Preferably, two teeth are connected to a single spring.

Preferably, the teeth and spring are integrally formed.

More preferably, the teeth extend from one or more springs.

Preferably, the teeth act as cantilever springs fixed to the mounting means.

Optionally, the cantilever springs are provided with additional pivot points to allow the spring tension to be adjusted.

Preferably, the mounting means is located inside the frame such that the teeth extend outwards from the frame through the seabed engaging portion of the frame.

Preferably, the angle at which the teeth contact the sea bed is adjustable.

Preferably, the frame further comprises funnelling means adapted to direct water into and through the frame.

Preferably the funnelling means comprises one or more extension piece which extends outwards from the frame.

Optionally, one of more of the open sides of the frame are enclosed to form at least part of the funnel.

In accordance with a second aspect of the invention there is provided a frame for a fishing dredge, the frame comprising:
a sea bed engaging portion and an upper portion and funnelling means adapted to direct water into and through the frame.

By directing water through the frame, the funnelling means may assist in moving the molluscs into the frame and belly and/or assist in the dispersion of matter such as sea weed or small stones which may block the mesh of the belly and reduce the efficiency of the dredge.

Preferably the funnelling means comprises one or more extension piece which extends outwards from the frame.

Optionally, one of more of the open sides of the frame are enclosed to form at least part of the funnelling means.

Preferably, the frame further comprises a mounting means located on the frame, a plurality of teeth which are coupled to the mounting means said teeth extending beyond the seabed engaging portion of the frame, wherein at least two of the teeth are resiliently mounted to move independently of one another.

Preferably, the seabed engaging portion of the frame further comprises one or more runner.

Preferably, the seabed engaging portion of the frame further comprises one or more wheel.

Optionally, the seabed engaging portion of the frame further comprises one or more track.

Preferably, the track is moveable.

Optionally the track is flexible.

Preferably, the teeth are resiliently mounted by means of a spring.

Preferably, the spring is coiled around the mounting means.

Optionally, the spring couples the mounting means to the tooth.

Preferably, two teeth are connected to a single spring.

Preferably, the teeth act as cantilever springs fixed to the mounting means.

Preferably, the angle at which the teeth contact the sea bed is adjustable.

Optionally, the cantilever springs are provided with additional pivot points to allow the spring tension to be adjusted.

Preferably, the mounting means is located inside the frame such that the teeth extend outwards from the frame through the seabed engaging portion of the frame.

### BRIEF DESCRIPTION OF THE DRAWINGS

The present invention will now be described with reference to the accompanying drawings in which:

FIG. 1 is illustrates the process of dredge fishing;

FIG. 2 illustrates a known type of fishing dredge;

FIG. 3 is a side view of a known type of fishing dredge frame and belly;

FIG. 4 is a side view of a first embodiment of a frame in accordance with the present invention;

FIG. 5 is a side view of a second embodiment of a frame in accordance with the present invention;

FIG. 6 is a rear view of the embodiment of the present invention shown in FIG. 4;

FIG. 7 is a top view of the embodiment of the present invention shown in FIG. 4;

FIG. 8 is a side view of a third embodiment of a frame in accordance with the present invention;

FIG. 9 is a rear view of the embodiment of the present invention shown in FIG. 8;

FIG. 10 is a top view of the embodiment of the present invention shown in FIG. 8;

FIG. 11 is a side view of a fourth embodiment of a frame in accordance with the present invention;

FIG. 12 is a bottom view of a fifth embodiment of the present invention;

FIG. 13 is a bottom view of a sixth embodiment of the present invention;

FIG. 14 is a side view the embodiment of the present invention shown in FIG. 13;

FIG. 15 is a side view of a seventh embodiment of the present invention; and

FIG. 16 is a bottom view of an eighth embodiment of the present invention.

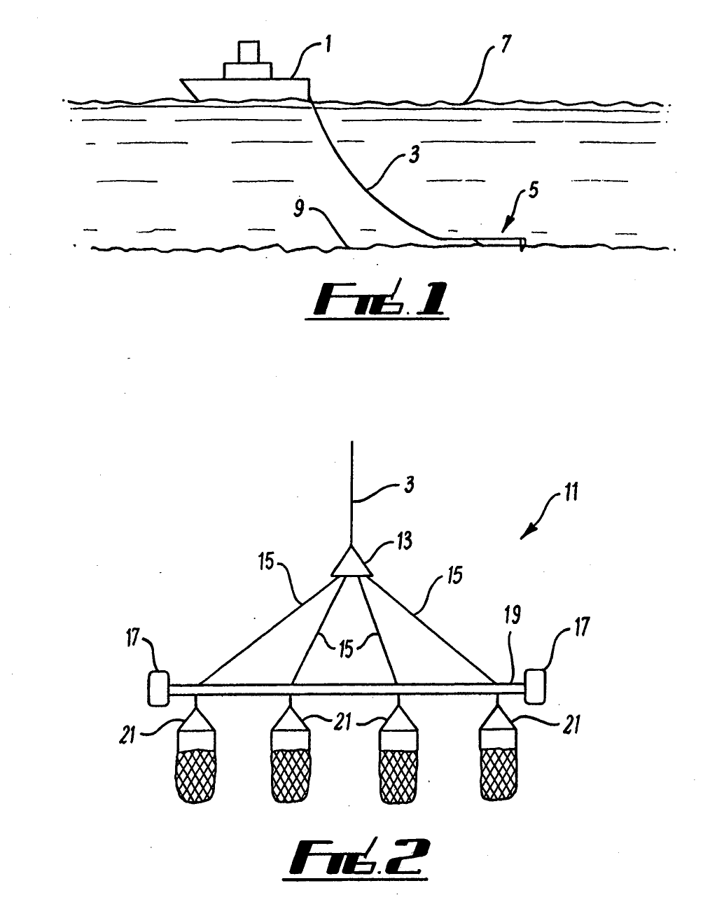

### DETAILED DESCRIPTION OF THE DRAWINGS

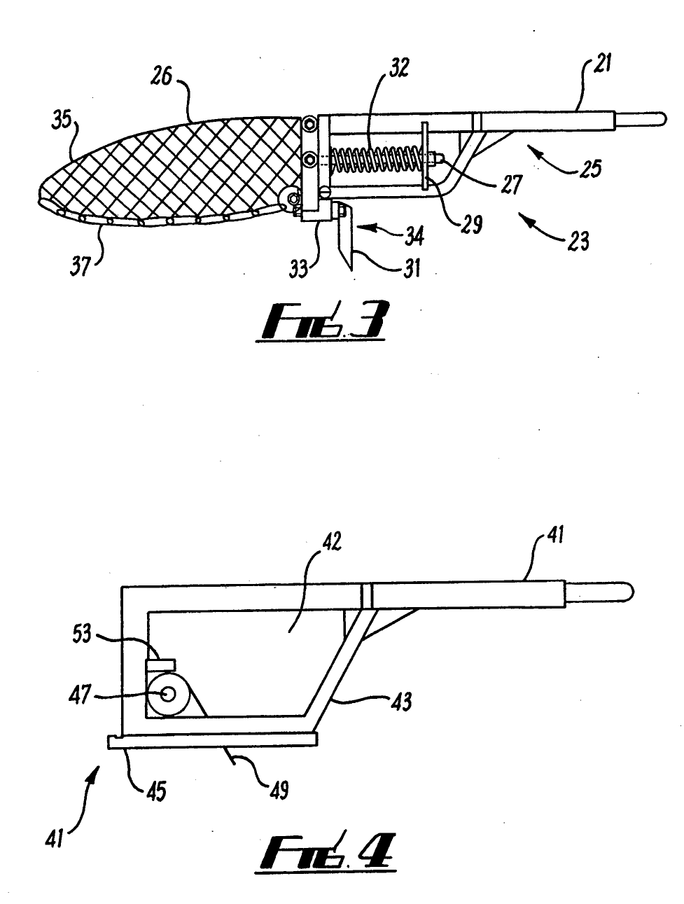

A first embodiment of the present invention is shown in FIG. 4. FIG. 4 is a side view which shows a frame 41 having an open side 42 which is supported by a diagonal frame member. In general the frame of the present invention has longer sides than the prior art frame shown in FIG. 3. The frame also has a ground engaging rail 45 which is in contact with the seabed and which in this embodiment slides along the seabed in use. Support beam 47 extends across the frame and supports the sword or tooth 49 which is attached to the support beam 47 by means of a helical winding 51 with which it is integrally formed and is an extension of the spring. An abutment 53 is positioned above the helical winding and acts to retain the tooth 49, helical winding 51 and support beam 47 in position. The tooth 49 extends outwards from the frame such that it can scrape the seabed in order to uncover molluscs. The example of FIG. 4 contains a plurality of teeth (not shown) each of which are separately resiliently mounted.

In this example of the present invention, the frame 41 is dragged along the seabed using rails 45 and the tooth 49 digs into the seabed in order to uncover molluscs. The frame 41 has eight teeth which are independently resiliently mounted on the support beam 47 such that when one of the teeth encounters a hard object such as a stone it will move backwards under tension in order to move over of the stone. As the teeth are all independently resiliently mounted the movement of one tooth over a stone does not affect the ability of the other teeth to continue the operation of digging into the seabed. Therefore even when one tooth encounters an object such as a stone and has to move, the remaining teeth can continue to collect molluscs.

It shall be noted that the same reference numerals have been used to similar or identical features in the following embodiments of the invention.

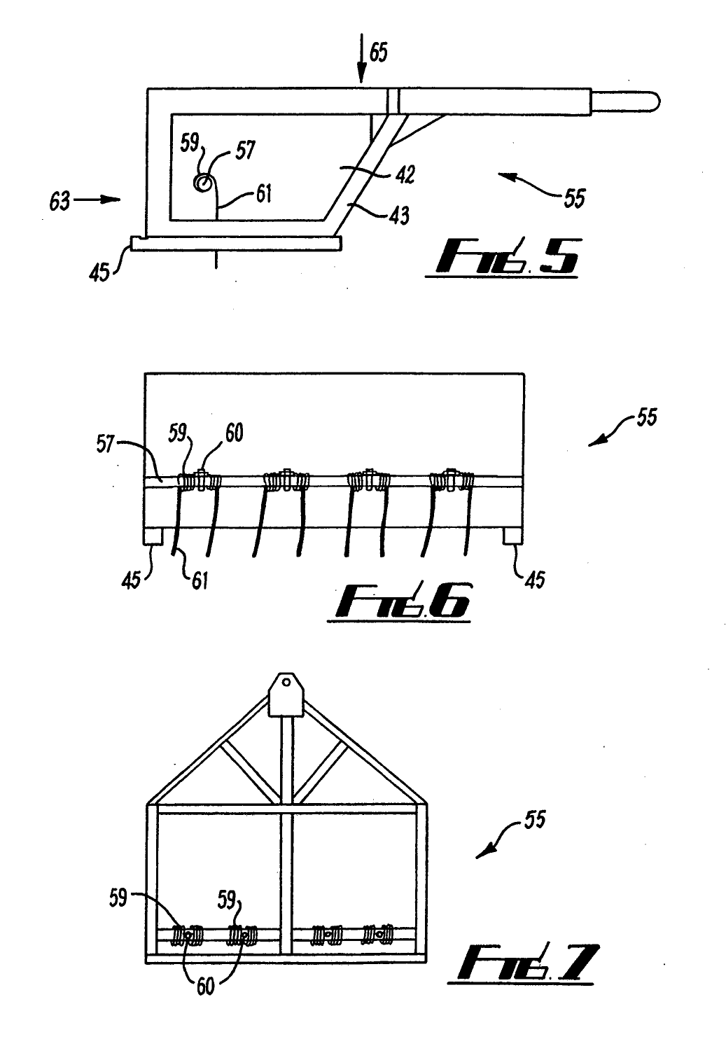

FIGS. 5, 6 and 7 show a second embodiment of the present invention. FIG. 5 is a side view of the frame 55 which has sides 43, an open side 42 and a seabed engaging rail 45. The embodiment further comprises a support beam 57 which contains a helical winding 59 and a tooth 61 extending down from the support beam beyond the rail 45 of the frame 55. The main difference between the second embodiment of the invention and the first embodiment of the invention is that the tooth is perpendicular to the ground engaging rail 45.

FIG. 6 is a view of the frame 55 from position 63 shown in FIG. 5. The shows the support 57 extending across the frame and having eight teeth extending downwards from the support beam 57. It will be noted that in this embodiment of the invention, the teeth are mounted in pairs in the following manner. Both teeth of a pair of teeth are made from a continuous piece of stiff wire which contains two helical sections connected together by a bridge section (not shown). The bridge is attached to the support beam 57 by means of a bolt 60.

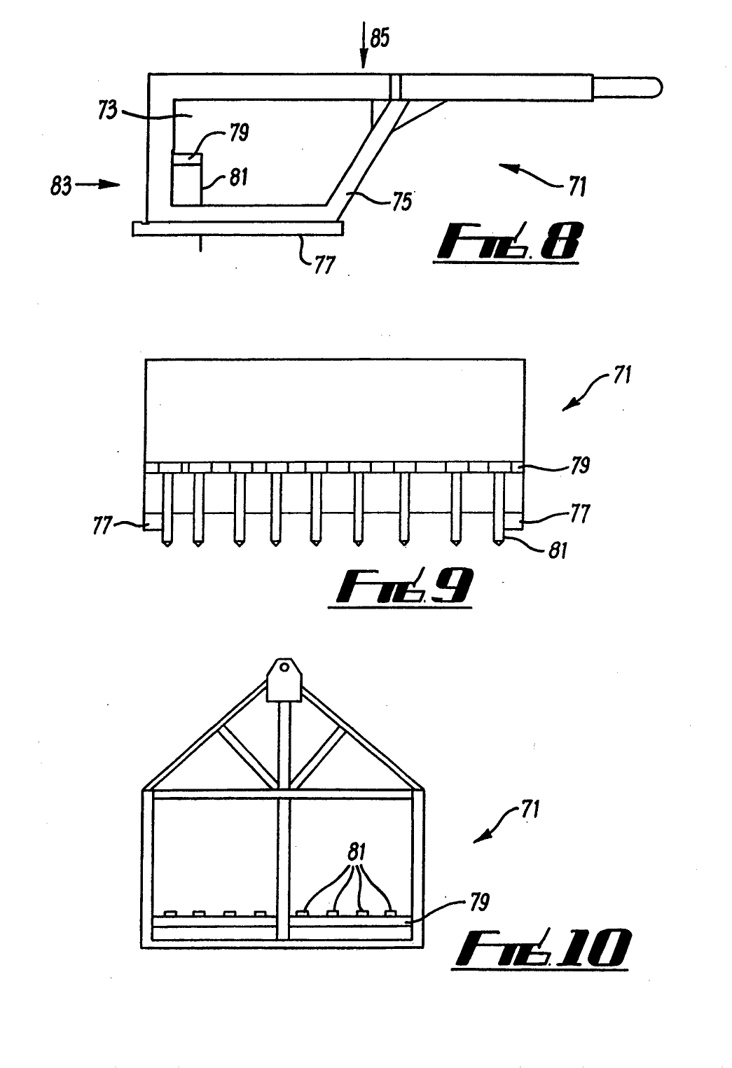

FIG. 7 is the top view of the frame 55 shown from position 65 in FIG. 5. This shows the bolt connector 60 in position between the two helical windings. It has been found that hay tines provide a suitable form of tooth for use with this embodiment of the present invention. Hay tines may also be used in the embodiment of FIG. 4 where the teeth are not connected in pairs.

FIGS. 8, 9 and 10 show a third embodiment of the present invention. In FIG. 7 the frame 71 comprises an open side 73, frame side 75 and seabed engaging rail 77. Support beam 79 is located inside the frame and tooth 81 extends down from the support beam 79 to a position beyond the seabed engaging rail 77.

FIG. 9 shows a view of the embodiment of FIG. 8 from the position 83. In this figure the support beam 79 is shown along with the teeth 81 which extend down from the support beam 79.

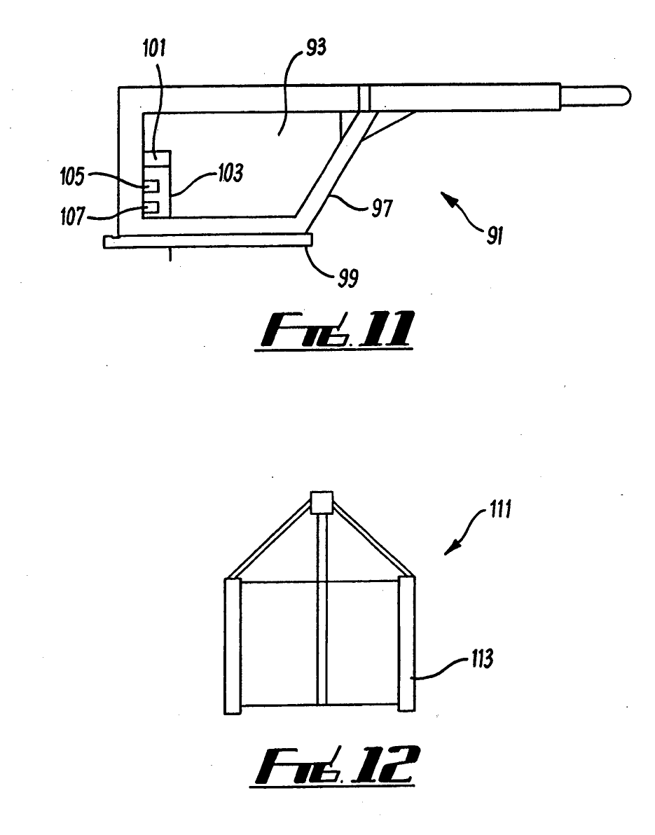

FIG. 10 shows a view of the embodiment of FIG. 8 from position 85. Support beam 79 and the 81 are shown therein.

In this embodiment of the present invention each tooth 81 is attached to the support beam 79 such that it forms a cantilever spring. Therefore when the dredge frame 71 is dragged along the seabed on rails 77 where one of the teeth encounters a hard object such as a rock it is able to move backwards under tension about the pivot point of the cantilever spring in order to move over of the rock.

FIG. 11 shows another embodiment of the present invention similar to that shown in FIGS. 8 to 10. FIG. 11 shows a frame 91 which has open side 93 formed by the frame side 97 and which has a seabed engaging rail 99. As with other embodiments of the present invention, the tooth 103 extends downwards from a support beam 101. However, in this embodiment of the present invention a cantilever spring is modified to include additional pivots 105 and 107. These pivots can be moved into and out of contact with the tooth 103 in order to change the tension of the cantilever spring.

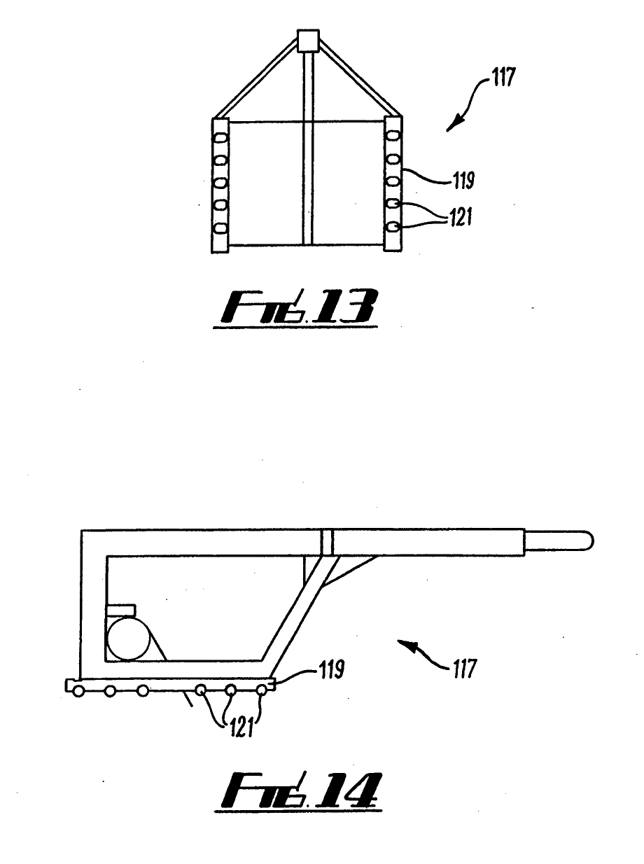

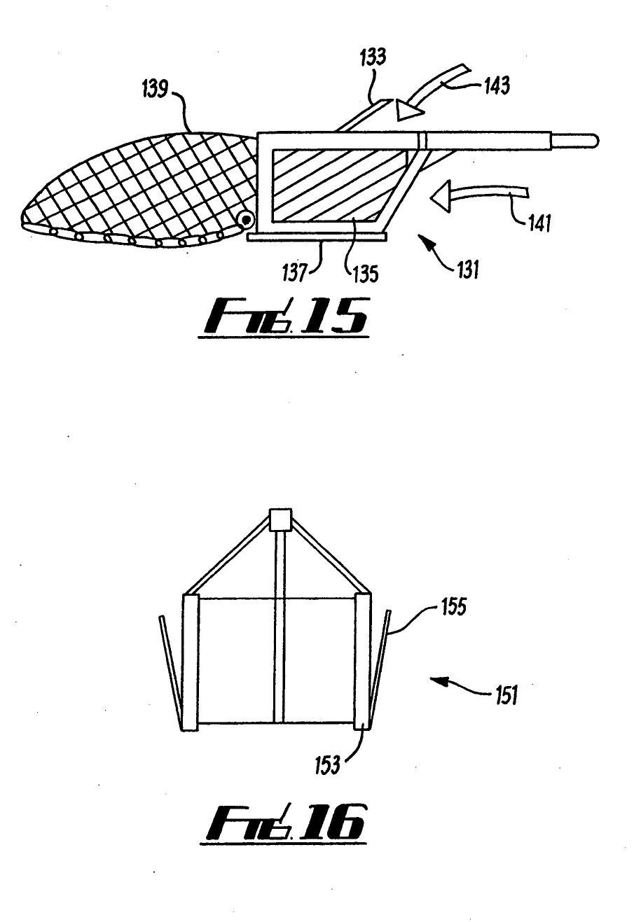

FIGS. 12, 13 and 14 show additional features of the seabed engaging rails of the present invention. FIG. 12 shows a frame 111 with a rail 113 which is a continuous smooth surface in this embodiment of the invention. FIG. 13 shows a rail 119 in which a number of rollers 121 are mounted. FIG. 14 is the side view of a frame 117 in accordance with the present invention and shows the rail 119 with rollers 121. The purpose of the rail is to assist with the smooth travel of the dredge across the seabed. In addition to the embodiments described above, the rails may be made of the flexible material or contain a movable track which allows the entire rail to rotate whilst the dredge is being dragged across the surface.

FIGS. 15 and 16 show the other embodiments of the present invention in which the dredge frame is fitted with funnelling means.

FIG. 15 shows a frame 131 having funnelling means 133 and 135 fitted to the frame. As with other embodiments of the present invention the frame has seabed engaging rails 137 and for completeness, a belly 139 is shown in this embodiment. With reference to the funnelling means 133 and 135, these components comprises a fin 133 which is fitted on top of the frame 131 and is designed to collect additional water and force this water through the frame. The direction of water flow is illustrated by reference numerals 143 and 143. Funnelling means 135 comprises a plate fitted to one or both sides of the frame 131 which at least in part encloses the sides of the frame. Funnelling means 135 therefore prevents water from escaping through the side of the frame and direct it through the belly 139.

The embodiment of the invention shown in FIG. 16 shows a frame 151 with the seabed engaging rail 153 and funnelling means 155. In this embodiment of the invention, the funnelling means 155 is fitted to the side of the frame but is angled outwards to allow for the collection of additional water as the dredge frame is being pulled along the seabed.

In use, the frame is pulled along the seabed and during the operation in which molluscs are dug up from the seabed, water travels through the frame. The embodiments of the invention shown in FIGS. 15 and 16 provide means for increasing the amount of water that passes through the frame and belly.

The advantage of this is that the water enters the frame and belly with greater force and provides a mechanism for removing dirt, small stones, vegetation or anything else that might have become stuck in the frame or belly. It should be noted that the built up of these items within the frame or belly causes a large amount of additional drag thereby making the dredge less efficient and eventually causing the fishermen to lift the dredge from the water to have it cleaned. The removal of dirt, small stones or vegetation or the like allows the dredge to be used for longer periods of time.

Improvements and modifications may be incorporated herein without deviating from the scope of the invention.

1. A frame for a fishing dredge, the frame comprising:
a sea bed engaging portion and an upper portion;
a mounting means located on the frame;
a plurality of teeth which are coupled to the mounting means said teeth extending beyond the seabed engaging portion of the frame; and
wherein at least two of the teeth are resiliently mounted to move independently of one another.

2. A frame as claimed in claim 1 wherein, the seabed engaging portion of the frame further comprises one or more runner.

3. A frame as claimed in claim 1 wherein, the seabed engaging portion of the frame further comprises one or more wheel.

4. A frame as claimed in claim 1 wherein, the seabed engaging portion of the frame further comprises one or more track.

5. A frame as claimed in claim 4 wherein, the track is moveable.

6. A frame as claimed in claim 4 wherein the track is flexible.

7. A frame as claimed in claim 1 wherein at least two of said teeth are mounted on separately resiliently mounted.

8. A frame as claimed in claim 1 wherein, the teeth are resiliently mounted by means of a spring.

9. A frame as claimed in claim 8 wherein, the spring is coiled around the mounting means.

10. A frame as claimed in claim 8 wherein, the spring couples the mounting means to the tooth.

11. A frame as claimed in claim 8 wherein, two teeth are connected to a single spring.

12. A frame as claimed in claim 8 wherein, the teeth and spring are integrally formed.

13. A frame as claimed in claim 8 wherein, the teeth extend from one or more springs.

14. A frame as claimed in claim 1 wherein, the at least one of the teeth act as cantilever springs fixed to the mounting means.

15. A frame as claimed in claim 14 wherein, the cantilever spring is provided with additional pivot points to allow the spring tension to be adjusted.

16. A frame as claimed in claim 1 wherein, the mounting means is located inside the frame such that the teeth extend outwards from the frame through the seabed engaging portion of the frame.

17. A frame as claimed in claim 1 wherein, the angle at which the teeth contact the sea bed is adjustable.

18. A frame as claimed in claim 1 wherein, the frame further comprises funnelling means adapted to direct water into and through the frame.

19. A frame as claimed in claim 18 wherein the funnelling means comprises one or more extension piece which extends outwards from the frame.

20. A frame as claimed in claim 18 wherein, one of more of the open sides of the frame are enclosed to form at least part of the funnel.

21.-40. (canceled)
